(19) United States
(12) Patent Application Publication
(10) Pub. No.: US 2023/0038073 A1
(43) Pub. Date: Feb. 9, 2023

(54) DELIVERY SYSTEM EMBEDDED TRAP DEVICE FOR ATTRACTING FEMALE AND MALE FRUIT FLIES

(71) Applicant: Manoj Kumar R, Yelahanka (IN)

(72) Inventors: Manoj Kumar R, Yelahanka (IN); Vivek KEMPRAJ, Srighandada Kavalu (IN); Vijeth V ARYA, Srighandada Kavalu (IN)

(21) Appl. No.: 17/758,527

(22) PCT Filed: Jan. 29, 2021
(86) PCT No.: PCT/IB2021/050698

§ 371 Date: Jul. 8, 2022

(30) Foreign Application Priority Data
Jan. 30, 2020 (IN) 202041004240

(51) Int. Cl. A01M 1/10; A01M 1/04

(52) U.S. Cl. CPC A01M 1/106; A01M 1/04

(57) ABSTRACT

A Delivery System Embedded Trap Device for Attracting Female and Male Fruit Flies is disclosed in the present invention which can attract both female and male of fruit flies for an extended period of 180 days irrespective of the season thereby effectively controlling the major pest in agriculture.

### CROSS-REFERENCE TO RELATED APPLICATION

The present application claims priority from the Provisional Application No. IN 202041004240 filed on Jan. 30, 2020, the full disclosure of which is hereby incorporated by reference herein.

### FIELD OF THE INVENTION

The present invention relates to a delivery system embedded trap device, in particular to a trap device for extended and controlled release of lure attracting female and male fruit flies.

### BACKGROUND OF THE INVENTION

Insect traps are vastly used both for monitoring and reducing the population of fruit flies. They typically use food, visual lures, chemical attractants and pheromones as bait and are installed so that they do not injure other animals or humans or result in residues in foods or feeds. Visual lures use light, bright colors and shapes to attract pests. Chemical attractants or pheromones may attract only a specific sex. Insect traps are used in pest management programs instead of pesticides but are more often used to look at seasonal and distributional patterns of pest occurrence. This information may then be used in other pest management approaches.

Flies are occasionally attracted by proteins. Many other insects are attracted by bright colors, carbon dioxide, lactic acid, floral or fruity fragrances, warmth, moisture and pheromones.

In case of the existing trapping technologies, the effect of lure will be reduced over a period of time, in which the attraction becomes nil over few days i.e., within 20-30 days. Hence the farmer needs to replace the lures at least thrice in one season. The present invention among other advantages detailed below, avoids replacing the lure for the whole season.

### OBJECT OF THE INVENTION

The main object of the invention is to develop a delivery system embedded trap device for attracting female and male fruit flies.

Another object of the invention is to provide a method of luring, trapping and killing insects or flies, specifically male and female flies such as fruit flies at all stages, using the instant inventive delivery system embedded trap device.

### SUMMARY OF THE INVENTION

The present invention discloses a delivery system embedded trap device for attracting female and male fruit flies. The device comprises Lure Reservoir, Control Release Knob, Connector or Spacing Adjustor, Circular-Pyramid, Sphere-Shaped Insect Attractant, Top Cover, and Bottom Cover. The device delivers the lure formulation in a controlled and extended way for a period of 180 days to attract the fruit files in one season, thus making it lasting for a long period.

In another aspect, the invention relates to a method of luring, trapping and killing insect or flies, specifically male and female flies such as fruit flies at all stages using the present invention trap device.

### BRIEF DESCRIPTION OF THE DRAWINGS

The following drawings form the part of the present invention and are included to substantiate and demonstrate the invention purely by way of example and non-limiting in which:

FIG. 1 illustrates Delivery system embedded trap device

FIG. 2 illustrates the perspective view of the Delivery system embedded trap device

### DETAILED DESCRIPTION OF THE INVENTION

As those of ordinary skill in the art will understand, various features of the embodiments illustrated and described with reference to any one of the Figures may be combined with features illustrated in one or more other Figures to produce alternative embodiments that are not explicitly illustrated and described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations consistent with the present disclosure, e.g., ones in which components or processes are arranged in a slightly different order than shown in the embodiments in the Figures. Those of ordinary skill in the art will recognize that the teachings of the present disclosure may be applied to other applications or implementations.

It will be appreciated that for simplicity and clarity of illustration, where appropriate, reference numerals have been repeated among the different figures to indicate corresponding or analogous components of the present invention.

The aspects and embodiments of the invention are described, referring to the accompanying drawings or figures and the reference numerals of the components in the drawings or figures.

The trap design according to the present disclosure is to attract both female and male fruit flies for extended period up to 6 months. The inventors of the present disclosure have conducted significant number of lab and field trials to examine the potential of the trapping attracting males and females fruit flies. From the trial, the inventors have concluded that the trap attracts a large number of male (1400 per trap) and females (1550 per trap) of any species.

The present disclosure trap device can be used to target any species of fruit flies both male and female and mostly gravid females (proven in lab and field studies). The trapping of fruit flies for extended period in field conditions irrespective of seasons decreased the future generations of fruit flies on a long run, thereby, linking the potential of present invention trapping system in IPM, fruit fly control and eradication programs. The trapping technology is environment friendly without any inclusion of toxic insecticide making the present invention/application technology robust. The present device is a cost effective, long lasting (3 month/trap) and eco-friendly technique of trapping male and female fruit flies for IPM in vegetable and fruit orchards. By installing 8-10 traps per acre (as per inventors study) both male and female fruit flies can be effectively monitored and trapped.

The novel delivery system embedded trap design can be filled with phagostimulants blend of any known formulation that attracts both male and female fruit flies.

The described technology is cost effective and traps more of females which are the main cause of fruit destruction. The extended release method of the present application device/trap is more effective in cases where farmers delay or forget to replace lures which might cause severe damage to the crop, in this case present device/trap helps more effectively as there is no need for the farmer to replace the lure in one crop season.

The following are illustrative embodiments referring to illustrative drawings, the following and the drawings in no way should be interpreted as to limit the shape of the components and the arrangements in the device.

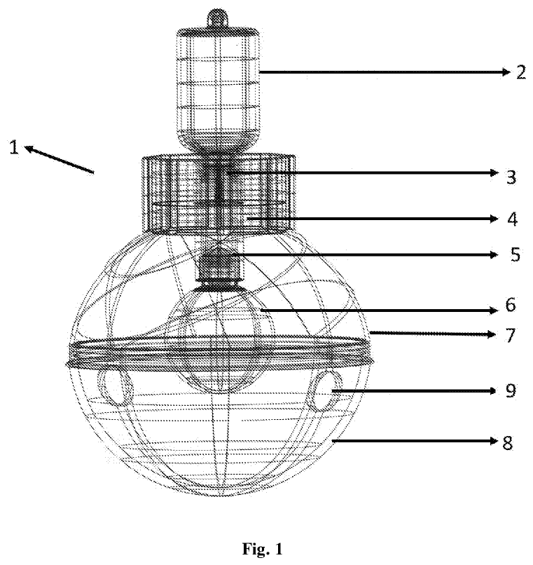

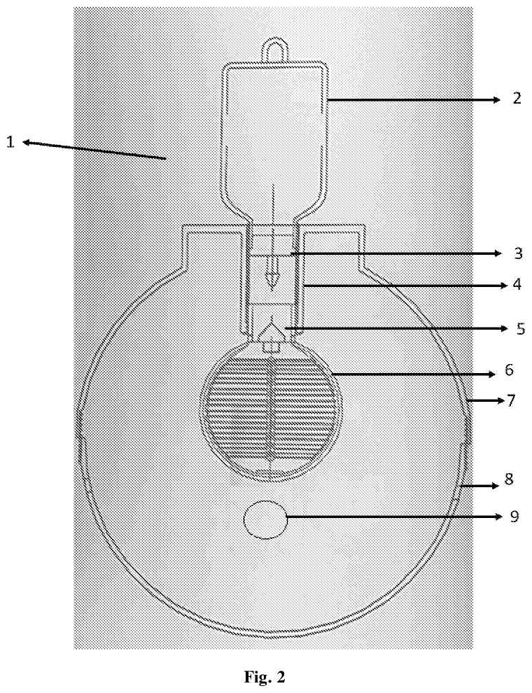

In an aspect, the invention provides a delivery system embedded trap device (1) for attracting female and male fruit flies, the device referring to non-limiting illustrative FIGS. 1 and 2, includes:

Lure Reservoir (2)

Control Release Knob (3)

Connector or Spacing Adjustor (4)

Circular-Pyramid (5)

Sphere-Shaped Insect Attractant (6)

Top Cover (7) and

Bottom Cover (8)

Openings (9)

In a non-limiting embodiment referring to illustrative FIGS. 1 and 2, the device is provided with a Lure Reservoir (2) which holds lure or attractant formulation in fluid form or semi fluid form. The reservoir is closed and configured with an opening, so as to not allow the whole lure to be exposed to atmosphere at the same time. Hence the consistency of attraction of the device stays till the reservoir is emptied.

In a non-limiting embodiment referring to illustrative FIGS. 1 and 2, the device is provided with a Control Release Knob (3), which is connected to the lure reservoir (2) and is provided in such a way, that only a particular amount of lure or attractant is released at any point of time. Knob is also provided with a mechanism for adjusting the release rate, controlling the release rate thereby increasing or decreasing the release rate of lure or attractant.

In a non-limiting embodiment referring to illustrative FIGS. 1 and 2, the device is provided with a Connector or Spacing Adjustor (4) below the lure reservoir, and connects the reservoir with Sphere-Shaped Insect Attractant (6). The adjustor provides delayed release of the lure fluid from the reservoir, by adjusting the gap maintained between the sphere and the reservoir, thereby modifying the time of flow of fluid lure.

In a non-limiting embodiment referring to illustrative FIGS. 1 and 2, the device is provided with a Circular-Pyramid (5), which is provided between the adjustor and sphere shaped Attractant (6); and is placed at 180 degree under the release knob. The pyramid is provided for letting the released fluid spread evenly on all side of the sphere attractant. It is placed at 180 degree under the release knob.

In a non-limiting embodiment referring to illustrative FIGS. 1 and 2, the Sphere-Shaped Insect Attractant (6) is connected to the reservoir via the Circular-pyramid (5) and the adjustor (4). The Sphere-Shaped Insect Attractant provides various functions. The functions includes providing large surface area for the attractant/lure to spread over, which in turn gives more area for the insects to come over and get trapped; delaying the exhaust of the lure, which provides more time for the attractant to work; and the Sphere-Shaped Insect Attractant may be made of deep yellow color or any color which can visually attract insects/flies, thus acting as a visual attractant for insects/flies such as fruit flies.

In a non-limiting embodiment referring to illustrative FIGS. 1 and 2, the device is provided with a Top Cover (7) which covers the adjustor, circular-pyramid, and protects the Sphere Shaped Insect Attractant, from adverse weather conditions such as wind, sun light and rain. Hence the fluid lure will last longer in the sphere, thereby increasing the luring or attracting capacity.

In a non-limiting embodiment referring to illustrative FIGS. 1 and 2, the device is provided with removable Bottom Cover (8), which is connected below the top cover by means of a screw arrangement; the bottom cover can be removed for discarding the trapped, collected and dead flies/insects. Further, the bottom cover is provided with two openings (9) on the one of each side, for allowing the entry of insects/flies in to the trap device.

In an exemplary embodiment, the bottom cover is made of deep yellow color, thereby acting as a visual attractant, so the flies enter the openings (9) of the bottom cover.

In an exemplary embodiment, all the components are to be made from PP virgin plastic or any such suitable material.

The another aspect of the invention provides a method for attracting and trapping of insects or flies using the delivery system embedded trap device, the method referring to FIGS. 1 and 2, comprises: placing formulation in the lure reservoir; adjusting the control release knob for releasing appropriate amount of lure in to Sphere-Shaped Insect Attractant via Connector or Spacing Adjustor, which delays the time of flow of fluid lure and Circular-Pyramid which spreads the lure across the surface area of the Sphere-Shaped Insect Attractant; the Sphere-Shaped Insect Attractant is protected with a top cover; and a removable bottom cover with two openings is attached to the top cover. Insects/flies are visually attracted towards the deep yellow colored Sphere-Shaped Insect Attractant wherein the insect/flies enter the bottom cover through the opening and get trapped in the lure formulation of the sphere, and collecting the trapped dead insects/flies by removing the bottom cover.

The device according to the present disclosure delivers the formulation at a slow rate for a period of up to 180 days to attract the flies in one season.

During field trails, the inventor(s) observed that an average catching of about 80 number of fruit flies are caught per the present device in highly infested fields, whereas about 30 flies were caught in moderately infested fields.

The device is cost-effective, eco-friendly used to monitor and eradicate fruit fly's population by trapping, a reusable trap design, attracts male and female flies of all stages with no use of insecticides or toxicants and highly recyclable.

These above features makes this invention unique, as it overcomes the problems being faced by farmers in existing trap models, i.e., to replace the lure in one season itself, whereas in the present application device/trap there is no need to replace lure in one whole season. This reduces the labor cost of the farmers to replace lures. This will take more market advantage as many farmers forget/delay to replace lures in traps, where the fruit fly damage increases in such cases even after using one trap in a season. But in this case there is no need for the farmer to revisit the field to replace the lure as it works for longer duration and also works consistently and more efficiently.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention.

1. A Delivery System Embedded Trap Device (1) for attracting female and male fruit flies, the device comprising:
i. a Lure Reservoir (2) for holding lure or attractant formulation in fluid form or semi fluid form;
ii. a Control Release Knob (3) connected to the lure reservoir (2) for releasing required amount of lure or attractant at any point of time, and provided with a mechanism for adjusting the release rate of lure or attractant;
iii. a Connector or Spacing Adjustor (4) provided below the lure reservoir (2);
iv. a Circular-Pyramid (5);
v. a Sphere Shaped Insect Attractant (6) connected to the reservoir via the Circular-pyramid (5);
vi. a Top Cover (7) provided for covering the adjustor, circular-pyramid, and protects the sphere shaped insect attractant, from adverse weather conditions such as wind, sun light and rain; and
vii. a Bottom Cover (8) connected below the top cover (7) by means of a screw arrangement;
wherein, the circular-pyramid (5) is provided between the adjustor (4) and sphere shaped Attractant (6); and is placed at 180 degree under the release knob; and the pyramid is provided for letting the released fluid spread evenly on all side of the sphere attractant; and
Wherein, the bottom cover is removed for discarding the trapped, collected and dead flies/insects; and bottom cover is provided with openings (9) on each side for allowing the entry of insects/flies in to the trap device;

2. The delivery system embedded trap device according to claim 1, wherein the adjustor provides delayed release of the lure fluid from the reservoir, by adjusting the gap maintained between the sphere and the reservoir, thereby modifying the time of flow of fluid lure.

3. The delivery system embedded trap device according to claim 1, wherein the sphere-shaped insect attractant provides a large surface area for the attractant/lure to spread over, and delaying the exhaust of the lure.

4. The delivery system embedded trap device according to claim 1, wherein the sphere shaped insect attractant is made of deep yellow color for visually attracting insects/flies.

5. The delivery system embedded trap device according to claim 1, wherein the bottom cover is made of deep yellow color, for visually attracting the flies to enter through the openings (9) of the bottom cover.

6. A Method for attracting and trapping of insects or flies using the delivery system embedded trap device (1) comprising steps of:
i. placing formulation in the lure reservoir (2);
ii. adjusting the control release knob (3) for releasing required amount of lure in to Sphere-Shaped Insect Attractant (6) via Connector or Spacing Adjustor (4), which delays the time of flow of fluid lure and Circular-Pyramid (5) which spreads the lure across the surface area of the Sphere-Shaped Insect Attractant; wherein the sphere-shaped insect attractant is protected with a top cover (7); and a removable bottom cover (8) with two openings (9) attached to the top cover;
iii. visually attracting insects/flies towards the deep yellow colored Sphere-Shaped Insect Attractant; wherein the insect/flies enter the bottom cover through the opening and get trapped in the lure formulation of the sphere; and
iv. collecting the trapped dead insects/flies by removing the bottom cover.

7. The method according to claim 6, wherein the sphere-shaped insect attractant provides a large surface area for the attractant/lure to spread over, and delaying the exhaust of the lure.

8. The method according to claim 6, wherein the sphere shaped insect attractant is made of deep yellow color for visually attracting insects/flies.
